(19) United States
(12) Patent Application Publication
(10) Pub. No.: US 2007/0247485 A1
(43) Pub. Date: Oct. 25, 2007

(54) Method and an Apparatus for Cleaning a Printhead

(75) Inventor: Karsten Holm Nikolajsen, Rodovre (DK)

Correspondence Address: WILLIAM J. SAPONE;COLEMAN SUDOL SAPONE P.C., 714 COLORADO AVENUE, BRIDGE PORT, CT, 06605, US

(73) Assignee: HS AUTOMATIC APS, DK-2610 Rodovre (DK)

(21) Appl. No.: 11/574,521

(22) PCT Filed: Aug. 31, 2005
(86) PCT No.: PCT/DK05/00556

§ 371 Date: Apr. 9, 2007

(30) Foreign Application Priority Data
Sep. 7, 2004 (DK) PA 2004 01345
Jun. 13, 2005 (DK) PA 2005 00860

(51) Int. Cl. B41J 2/165

(52) U.S. Cl. 347/28; 347/30

(57) ABSTRACT

A method and an apparatus for cleaning the printhead (1) of an ink printer, in particular a printer used in connection with industrial printing tasks e.g. on a package, wherein the cleaning takes place by means of vacuum, there being created a “vacuum-effect”, where the vacuum is established in a gap or a channel (6) defined by the surface of the printhead (1) and a cover plate (5), which covers the printhead completely or partly, and which is part of the printhead. The gap or the channel (6) is connected flow-wise with a vacuum generator, such as a vacuum pump (7). The cover plate may be stationary relative to the print head, but it may also be displaceable in its plane between two positions in which it uncovers the printhead and covers it completely, respectively. The system may comprise an ink pump (9) which may press ink out through the nozzles (2) of the printhead. The system may additionally comprise a container with cleaning liquid and a controlled supply of cleaning liquid to the front plate of the print-head and the row of nozzles.

### THE PRIOR ART

The invention relates to a method of cleaning the printhead of an ink printer, wherein the surface of the printhead and/or the ink nozzles of the printhead are cleaned by means of a vacuum, which is established in the area around the surface of the printhead and creates a vacuum-cleaner effect, as well as an apparatus for performing the method.

When printing with a printhead, this takes place in that the nozzles of the head eject small ink drops toward the item which is being printed. As the amount of ink ejected in the individual drops is very small, it only takes small impurities to clog the nozzles or to deflect the ink drops. It may be dust or other foreign matter from the surroundings which adhere to the nozzles and thereby impair or destroy the quality of the print-out which is planned. Particularly in connection with industrial printers which print in connection with conveyor belts and often on cardboard boxes and the like, complete or partial clogging of nozzles will be a frequent problem.

In a conveyor belt, it may be necessary to print upwards, on the side or from above and down on the items. Thus, it is necessary that cleaning of nozzles may take place irrespective of the direction in which printing takes place.

To this should be added that in the cleaning or so-called purging of the nozzles it is desired that other/more impurities are not added to the nozzles or to the ink, if it is decided to use this again. In other words, it must be a “clean” cleaning of the nozzles that takes place. An example of an unclean cleaning is the use of compressed air to blow the nozzles clean, since compressed air frequently contains water (which results in corrosion of the nozzles), oil and particles (which per se may cause clogging).

Known are also arrangements for cleaning printheads, where the cleaning takes place by means of vacuum which sucks impurities away from the surface of the printhead. The use of vacuum eliminates many of the above-mentioned drawbacks.

Such a vacuum system is described in U.S. Pat. No. 5,138,334. In this system, a cap is arranged above the printhead and at a small distance from it. The cap has a channel which is arranged directly at the nozzles and which is connected with a source of vacuum. The channel is rounded toward the end so as to create a flow path between the cap and the surface of the printhead, whereby impurities, such as pieces of cardboard and colour residues, may be sucked away. The cap may also be used for priming the printer, as it is then placed in engagement with the printhead, whereby ink is sucked out through the nozzles for priming the printer.

In this system, the cleaning process takes place when the printhead is placed in a parking position in a maintenance station. The cap is part of this station and is connected with the printhead from the outside. Thus, cleaning cannot take place when the printers are in the working position.

### THE OBJECT OF THE INVENTION

The object of the invention is to provide a method and a system for cleaning a printhead by means of vacuum, where cleaning may take place while print items are present in front of the printhead. Thus, it is possible to clean the printhead without moving an external unit down in front of the printhead, or without moving the printhead to a maintenance station.

This object is achieved by a method as defined in claim 1 and an apparatus as defined in claim 8.

When the vacuum is established in the gap defined by a cover plate which extends over the surface of the printhead and covers part of or the entire surface at a distance from it, and which is connected with the printhead, it is possible to clean the printhead while it remains in the working position. The strength of the vacuum and the gap between the printhead and the cover plate may be adapted such that the required “vacuum-cleaner effect” is provided. Cleaning may be performed in all positions of the printhead irrespective of the printing direction, and without drops of ink falling down to contaminate the surroundings.

When the printhead is to be cleaned, the print-out is stopped, and a vacuum generator, such as a vacuum pump, is started, an ink pressure being optionally provided beforehand e.g. by the use of an ink pump which presses ink out through the nozzles. The vacuum sucks ink and impurities away from the nozzles and the surface of the printhead, without impurities from the surroundings entering the nozzles. The printhead remains in the working position during the entire process; thus, it is not necessary to park it at another location, such as in a maintenance station. It is even possible to perform the cleaning in operation between two prints-out.

It is possible to use a cover plate which is stationary relative to the printhead, as stated in claim 2, or mechanically displaceable between a position in which it covers the printhead completely, and in which the printhead is not covered at all, as stated in claim 3. In the first-mentioned embodiment, the printhead is covered permanently up to the nozzles so that the printing function is not prevented. In this embodiment, an ink pump or another form of ink pressure generator may be used, which presses ink out through the nozzles during cleaning, as stated in claim 4. This ink is sucked away through a channel together with the impurities.

When, as stated in claim 5, the displaceable cover plate is allowed to cover the printhead completely and allowed to engage a wall extending from the printhead, a closed space is provided, whereby the vacuum may suck ink out of the printhead. This embodiment may also be used for priming or purging the nozzles, and the cleaning may be performed without the generation of an ink pressure.

When, as stated in claim 6, the displaceable cover plate is allowed to move from the closed position to an open position, the entire surface of the printhead may be “vacuum-cleaned” during the movement, resulting in an effective cleaning.

This effect may be supplemented, as stated in claim 7, by using a container with a controllable inlet for cleaning liquid which is fed to the front plate and the row of nozzles on the printhead after the cover plate has been placed in the position in which it engages the said wall and closes the gap between the cover plate and the printhead completely. Cleaning liquid is sucked via the vacuum or is pressed via a pump out of a container to the gap before or during the subsequent withdrawal of the cover plate. A generated ink pressure, e.g. by the use of an ink pump, ensures a small flow of ink out of the nozzles, so that no cleaning liquid enters into them.

An apparatus for performing the method is defined in various embodiments in claims 8-12. When a filter is arranged in the channel in which the vacuum is generated, as stated in claim 12, the withdrawn ink may be filtered and optionally used again.

### THE DRAWING

The invention will be explained more fully with reference to the drawing, in which

FIG. 1 shows the cleaning system with a stationary cover plate,

FIGS. 2-5 show the cleaning system where the cover plate is displaceable in various stages of the cleaning process,

FIGS. 6-9 show an embodiment with a displaceable cover plate, where an ink pressure is generated using an ink pump, and

FIGS. 10-14 show an embodiment where the apparatus additionally has a controlled inlet for cleaning liquid to the nozzles and the front plate of the printhead from a container with cleaning liquid.

### DESCRIPTION OF THE EXEMPLARY EMBODIMENTS

FIG. 1 shows a printer with a printhead 1 having a row of nozzles 2 which send ink drops 3 down to the surface on which printing is to be performed 4. A cover plate 5 overlaps or covers part of the printhead 1 in such a manner that the row of nozzles 2 and the path of the ink drops 3 are free, thereby creating a gap 6 between the cover plate 5 and the surface of the printhead 1. This gap is in flow communication via a vacuum channel 13 with a vacuum generator, such as a vacuum pump 7, through a filter 8.

FIG. 1 shows an embodiment with a stationary cover plate 5. Ink is ejected from the row of nozzles 2 of the printhead 1 during printing. Printing cannot take place during cleaning. When cleaning is performed, the printing is stopped, and an ink pressure generated by the ink pump 9 is activated. The ink pump 9 presses ink out of the nozzles 2 so that ink flows on the front plate of the printhead around the nozzles. A suitable vacuum generated by the vacuum generator 7 sucks ink, air and impurities away from the nozzles through the gap 6 which is present between the cover plate 5 and the printhead 1. Impurities and ink are sucked through the filter 8 via the vacuum channel 13. The cover plate 5 is positioned such that a controlled suction across the row of nozzles 2 (vacuum cleaner effect) is created during the cleaning. As shown in the drawing, the cover plate 5 is also positioned such that it does not prevent the ink drops 3 from impinging on the material 4 on which printing is performed. The height of the gap and the size of the vacuum are adjusted so as to provide effective cleaning of the nozzles 2.

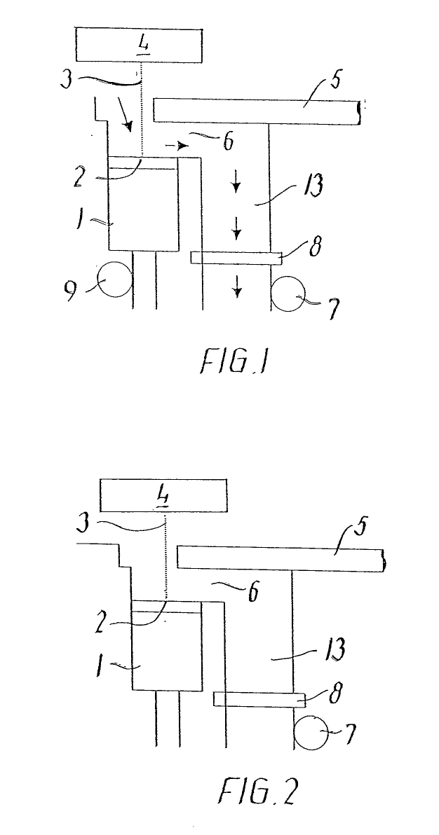

FIG. 2 shows a set-up with a movable cover plate 5 and with primer and cleaning functions integrated—without an ink pump.

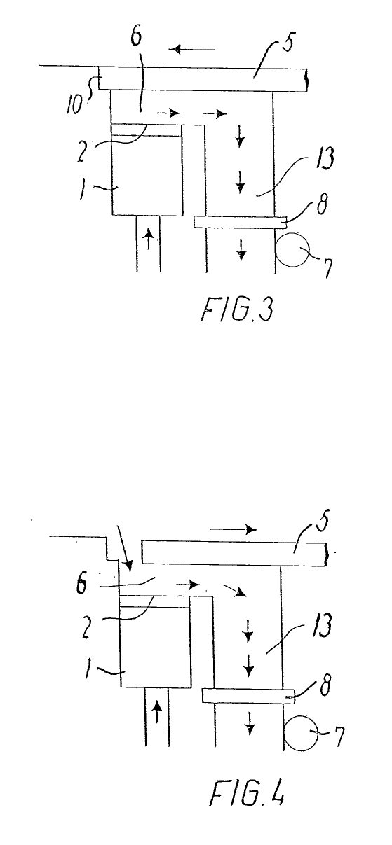

This solution is different from the stationary set-up in that the cover plate 5 may be pushed mechanically inwards over the printhead 1 and thereby create a closed gap 6, FIG. 3, the vacuum sucks ink from the ink chamber behind the printhead 1 out through the nozzles 2 via the gap 6 between the cover plate 5 and the surface of the printhead 1 down through the vacuum channel 13 through the filter 8 down to the vacuum generator 7. FIG. 2 shows the open position in which printing may be performed. This solution allows priming and cleaning without the use of a pump for pressing ink out through the nozzles.

When the nozzles are to be cleaned or primed, the cover plate 5 is pushed inwards over the printhead 1, thereby providing a tight seal to the surroundings, and the vacuum generator is started. This is shown in FIG. 3.

The created vacuum now sucks ink out of the nozzles 2. This may also be used for making the printhead 1 ready for print-out by creating a flow through all the nozzles 2, and ensures that the ink supply system itself is filled with ink (the ready-making removes any impurities), and the printhead and the print system are hereby made ready for printing.

It may also be the first step in the removal of impurities (dust, particles, etc.) from the nozzles 2. The ink which is sucked out through the nozzles by the vacuum, removes any impurities that might adhere on/in these. The closed cover plate 5 is shown in FIG. 3. The suction follows the arrows indicated in the drawings.

Controlled withdrawal of the cover plate 5 creates a form of vacuum-cleaner effect along the upper side of the printhead 1. This has the advantage over the stationary set-up that it is possible to vacuum-clean the entire surface of the printhead 1, thereby avoiding accumulation of impurities to the left of the row of nozzles 2 on the printhead 1.

Opening of the cover plate 5 is shown in FIG. 4. Full opening of the cover plate 5 is shown in FIG. 5. The cover plate 5 may be run right back to the edge of the vacuum channel 13 in which the filter 8 and the vacuum generator 7 are provided. This allows particles larger than the distance between the cover plate 5 and the printhead 1, to be “vacuum-cleaned” down into the wider vacuum channel 13.

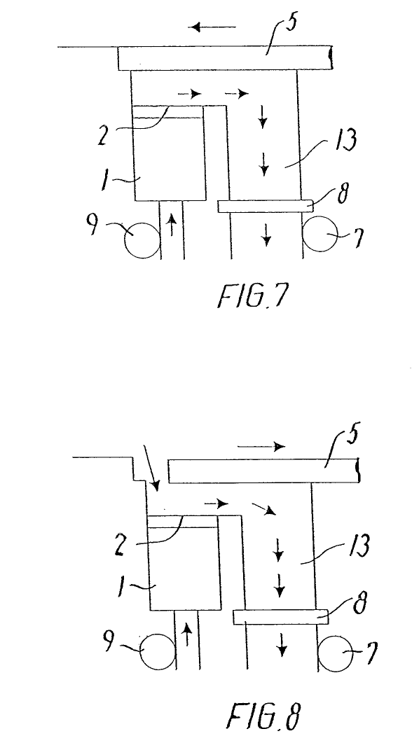

FIG. 7 shows a set-up with a movable cover plate 5 (integrated primer and cleaning functions—with an ink pump 9).

This solution is largely the same as the set-up with a movable cover plate—without an ink pump.

Cleaning and making-ready for print-out take place like for the system with the cover plate without a pump, with the sole difference that an ink flow may be generated both by means of vacuum and by an ink pressure generated by e.g. an ink pump 9.

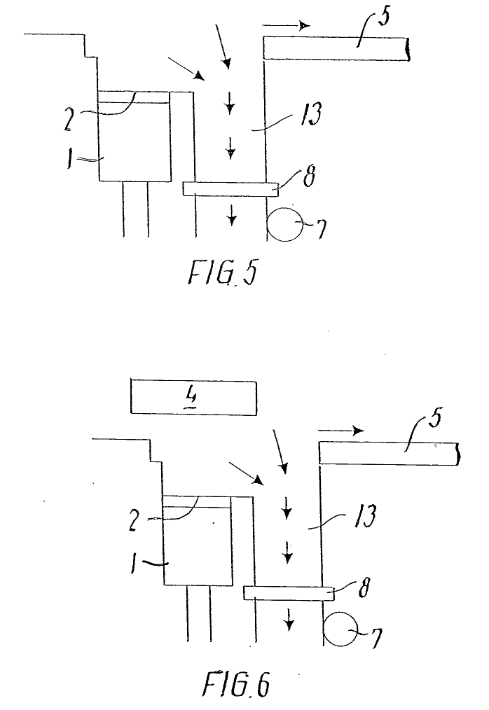

When the nozzles 2 are to be cleaned or made ready for print-out, the cover plate 5 is pushed inwards over the printhead 1, thereby providing a tight seal to the surroundings, and the vacuum generator 7 is started at the same time as an ink pressure is generated by the starting of the ink pump 9. This is shown in FIG. 6.

The ink pump 9 now presses ink out of the nozzles 2 at the same time as the vacuum sucks the ink away from the nozzles 2. This may also be used for making the printhead 1 ready for print-out by creating a flow through all the nozzles 2, which “loosens the system up” and ensures that the ink supply system itself is filled with ink (removes any impurities), and the printhead 1 and the print system are thereby made ready for printing.

It may also be the first step in the removal of impurities (dust, particles, etc.) from the nozzles 2. The ink which is sucked out through the nozzles 2 by the vacuum, removes any impurities that might adhere on/in these. An example of a closed cover plate 5 is shown in FIG. 7. The suction follows the arrows indicated in the drawings.

Controlled withdrawal of the cover plate 5 creates a vacuum-cleaner effect along the upper side of the printhead 1. This has the advantage over the stationary set-up that it is possible to vacuum-clean the entire surface of the printhead 1, thereby avoiding accumulation of impurities to the left of the row of nozzles 2 on the printhead 1.

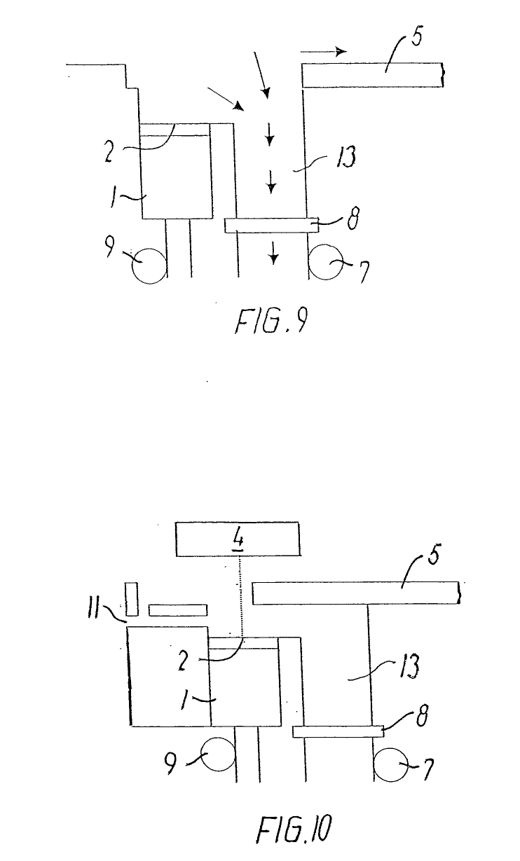

Opening of the cover plate 5 is shown in FIG. 8. Full opening of the cover plate 5 is shown in FIG. 9. The cover plate 5 may be run right back to the edge of the vacuum channel 13 in which the filter 8 and the vacuum generator 7 are provided. This allows particles larger than the distance between the cover plate 5 and the printhead 1 to be “vacuum-cleaned” down into the wider vacuum channel 13.

The advantage of the three illustrated solutions is that priming and cleaning may be performed irrespective of whether the head is directed upwards, downwards or is mounted for printing on the side of an article. This means that the cleaning system may be used irrespective of the position of the head. The ink pressed or sucked out by priming or cleaning is controlled by the suction and will not drip down on the items on which printing is to be performed. This makes the cleanings clean solutions in the production environment. There is no waste or particles in the air when the printhead is cleaned or made ready.

Both solutions may take place between each individual print, e.g. during the time between print on each box on a conveyor belt.

The controlled suction (vacuum-cleaner effect) prevents particles from being sucked from a large area past the nozzles, and the risk of damaging/contaminating the nozzles in the cleaning process is reduced thereby.

The controlled suction is based on the air which is already present in the surroundings, and not on e.g. compressed air with a high content of water/oil/particles.

The solution with a movable cover plate involves a further advantage. The advantage is that this solution—because the cover plate may be run right back over the vacuum channel—can remove larger particles than the stationary solution when the cleaning procedure is to be carried out.

The system may be extended with the use of cleaning liquid in a maintenance cycle for ink (with and without an ink pump):

The system is composed as shown in FIGS. 10-14.

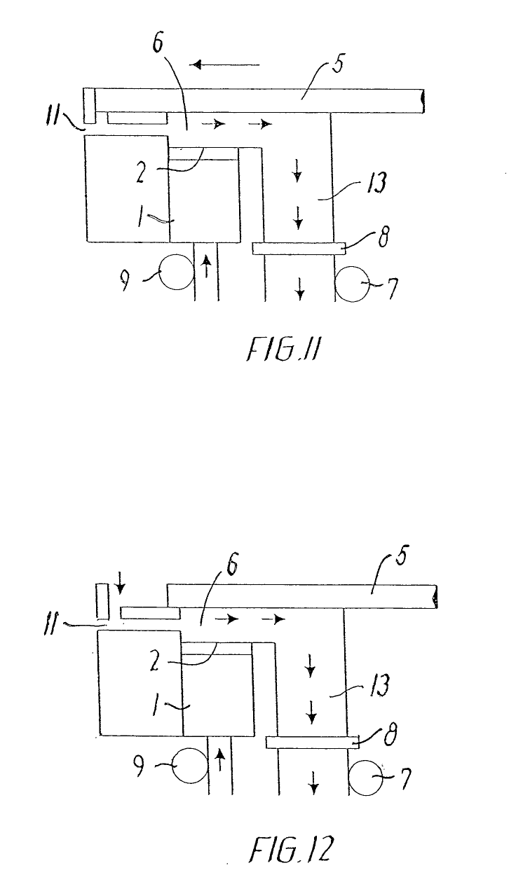

The system is an extension of the system already described with a movable cover plate 5, and which also uses an ink pressure e.g. generated by an ink pump 9, and comprises a further cleaning with cleaning liquid. This is shown in FIG. 11. The system operates according to the same principles as the systems with a movable cover plate. When the cleaning process is started, printing is stopped, and the cover plate 5 is moved inwards. Then, the ink pump 9 is started, which presses ink out through the nozzles 2 and out on the front plate on the printhead 1.

Immediately after the ink pump 9 has been started, the vacuum generator 7 is started. The vacuum sucks ink, air and impurities from the gap 6 between the cover plate 5 and the printhead 1 down into the vacuum channel 13 and through the filter 8 to a container (not shown). The generated vacuum will simultaneously suck cleaning liquid from a container with cleaning liquid, connected with the cleaning liquid inlet 11, into the gap 6 between the cover plate 5 and the printhead 1 and thereby fill it with cleaning liquid which flows across the nozzles 2. The ink pump 9 ensures a small flow of ink out through the nozzles 2 and thereby protects the ink with which printing is to be performed against contamination from the cleaning liquid.

After cleaning with cleaning liquid, the cleaning liquid inlet 11 is closed and the cover plate 5 is pushed slowly back, as shown in FIG. 12. Small openings leading into the cleaning liquid inlet will be uncovered first, and the remaining cleaning liquid in the cleaning liquid inlet will be sucked into the space 6 between the cover plate 5 and the printhead 1, across the nozzles 2 and down into the vacuum channel 13 by the generated vacuum from the vacuum generator 7.

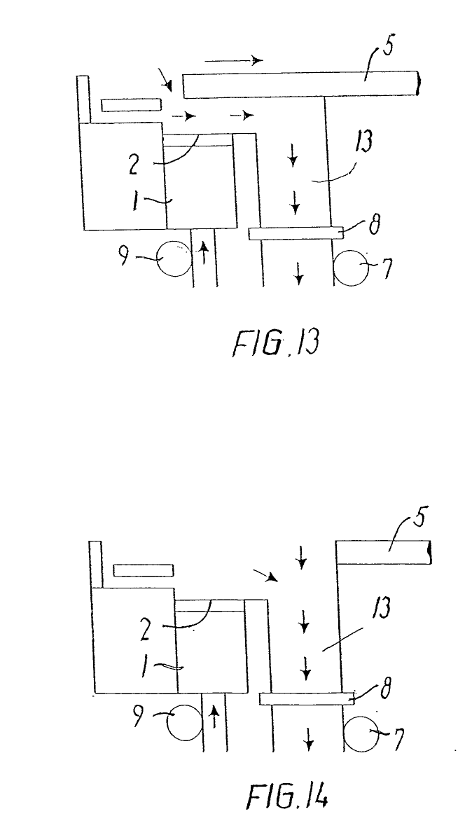

Then, as shown in FIG. 13, the cover plate will move across the printhead 1 and create a vacuum-cleaner effect which sucks ink, cleaning liquid, residual particles and air down into the vacuum channel 13. The cover plate 5 may be pulled back so that the vacuum channel 13 is fully open, as shown in FIG. 14, whereby particles larger than the distance between the cover plate 5 and the printhead 1 may be sucked down into the vacuum channel 13.

Version without an ink pump as shown in FIGS. 1-6:

Operates according to the same mechanisms as the version with an ink pump. The difference is that the ink flow out of the nozzles 2 is generated by the vacuum and not by a pressure from the ink pump. Contamination of the ink with cleaning liquid is avoided as the “vacuum-cleaner effect” from the withdrawal of the cover plate 5 sucks ink and any penetrated cleaning liquid out of the nozzles 2.

It applies to both systems:

Blocking the supply of cleaning liquid may allow the systems to be used for also priming the ink system.

The cover plate may be manipulated by means of pneumatics, hydraulics, electricity or by means of mechanics and may be adjusted by generally known or purpose-made adjustment equipment.

A form of valve is used for the metering of cleaning liquid, and this valve may be a simple and/or controlled valve, or a valve which is adapted to open at a specific vacuum. When the negative pressure necessary for the valve is no longer present, the valve closes, and the cleaning liquid which has been let out, is sucked away from the printhead by means of the residual vacuum.

1. A method of cleaning a printhead (1) of an ink printer comprising cleaning a, surface of the printhead and/or ink nozzles (2) of the printhead by means of a vacuum, established in an area around the surface of the printhead, creating a vacuum-cleaner effect, establishing the vacuum in a gap (6) and a channel (13), connected with a vacuum generator (7), formed by the surface of the printhead (1) and a cover plate (5) connected with the printhead, said cover plate covering at least a portion of the surface of the printhead (1) and being spaced from it.

2. A method according to claim 1, characterized in that the cover plate (5) is stationary and covers such a small portion of the printhead (1) that the nozzles (2) of the printhead are free.

3. A method according to claim 1, characterized in that the cover plate (5) is displaceable between a position in which it covers the printhead (1) completely, and in which it covers the printhead (1) partly or not at all.

4. A method according to claim 1, characterized in that an ink pressure, generated by the use of an ink pump (9) pressing ink out through the nozzles (2), is started to establish an ink flow through the nozzles, following which vacuum is established in the gap (6) between the cover plate (5) and the printhead (1) and in the filter gap (13), said vacuum generator (7) being activated.

5. A method according to claim 3, characterized in that the displaceable cover plate (5) is caused to cover the printhead (1) completely, and that it is caused to engage a wall (10) at the most remote end of the printhead (1), following which the vacuum generator (7) is activated.

6. A method according to claim 5, characterized in that the displaceable cover plate (5) is moved from the engagement with the wall to a position in which it does not cover the printhead (1).

7. A method according to claim 3, characterized by additionally using an ink pressure and cleaning liquid from a container with a controllable inlet (11) in a course where the ink pump (9) is started, the vacuum generator (7) is activated, the cleaning liquid inlet is opened, whereby the gap (6) between the printhead (1) and the cover plate (5) is filled with cleaning liquid, the cleaning liquid inlet is closed, and the cover plate (5) is withdrawn to the open position.

8. An apparatus for cleaning the printhead of an ink printer, wherein the surface of the ink head (1) and/or the ink nozzles (2) of the ink head are cleaned by means of a vacuum which is established in the area around the surface of the ink head and creates a vacuum-cleaner effect, characterized by a cover plate (5), which is connected with the printhead (1) and covers the surface of the printhead (1) completely or partly and defines, together with it, a gap (6) and a channel (13), said cover plate (5) extending at a distance from the surface of the printhead, said channel (13) being connected through a pipe connection with a vacuum generator (7), such as a vacuum pump.

9. An apparatus according to claim 8, characterized in that the cover plate (5) is stationary relative to the printhead (1) and covers an area of it which extends inwards to the nozzles (2) of the printhead, and which is either provided with an ink pump (9) adapted to press ink out of the nozzles (2), and/or with a vacuum generator (7) for withdrawing ink.

10. An apparatus according to claim 8, characterized in that the cover plate (1) is mechanically displaceable relative to the printhead (1) from a position in which it covers the printhead (1) completely, to a position in which it covers the printhead (1) partly or not at all, and that a wall (10) is present at the edge of the cover plate in the first-mentioned position, said cover plate (5) engaging said wall in this position.

11. An apparatus according to claim 8, characterized by moreover including a container for cleaning liquid with a controllable inlet (11) to the gap (6) between the printhead (1) and the cover plate (5).

12. An apparatus according to claim 8, characterized in that the vacuum channel (13) or the pipe connection is provided with a filter (8).

13. A method according to claim 2 characterized in that an ink pressure, generated by the use of an ink pump (9) pressing ink out through the nozzles (2), is started to establish an ink flow through the nozzles, following which vacuum is established in the gap (6) between the cover plate (5) and the printhead (1) and in the filter gap (13), said vacuum generator (7) being activated.

14. A method according to claim 5 characterized by additionally using an ink pressure and cleaning liquid from a container with a controllable inlet (11) in a course where the ink pump (9) is started, the vacuum generator (7) is activated, the cleaning liquid inlet is opened, whereby the gap (6) between the printhead (1) and the cover plate (5) is filled with cleaning liquid, the cleaning liquid inlet is closed, and the cover plate (5) is withdrawn to the open position.
